(19) United States
(12) Patent Application Publication
(10) Pub. No.: US 2010/0281481 A1
(43) Pub. Date: Nov. 4, 2010

(54) APPARATUS AND METHOD FOR PROVIDING A USER INTERFACE WITHIN A COMPUTING DEVICE

(75) Inventors: Roope Rainisto, Helsinki (FI); Martin Schuele, Tampere (FI); Mox Soini, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/433,035

(22) Filed: Apr. 30, 2009

(51) Int. Cl. G06F 3/048; G06F 9/46

(52) U.S. Cl. 718/100; 715/781

(57) ABSTRACT

A user interface for simultaneously representing tasks and notifications in a computing device. The user interface presents the tasks as reduced size representations of the output of the corresponding tasks which are continually updated. The user interface allows a user to bring a selected task to the foreground or to close the task, both by interacting with the representations of the tasks. The user interface further associates notifications with corresponding tasks by superimposing an icon of the notification on the representation of the corresponding task. The user interface orders and arranges the task representations and icons of the notifications according to certain layout rules.

### TECHNICAL FIELD

Embodiments relate generally to computing devices and, more particularly, to providing a user interface within a computing device.

### BACKGROUND

Computing devices comprise hardware and software components. The software is generally arranged as an operating system which regulates interaction between other software components and the hardware components and a plurality of user applications. A user then interacts with the computing device through one or more of the user applications by means of the operating system.

Traditionally, operating systems were only able to operate a single user application at a time and, if a user wished to utilise another application, it was necessary to terminate the currently-open application. Nowadays however operating systems are multi-tasking and are able to run a number of user applications simultaneously by means of a process known as a “multi-threading”.

Multi-tasking operating systems have allowed users to perform a number of simultaneous operations using a single computing device and quickly transfer information between applications running on the device. However, a proliferation of applications can cause a confusing operating environment. In particular, where a number of applications are simultaneously running on a device, generally only one of these applications will be available for interaction with the user. An application in this state is generally referred to as being in the “foreground”. Other applications are referred to as being in the “background”. Background applications are not however suspended and the operating system ensures that any processing required for these background applications will continue to occur, albeit at a lower priority than the foreground application. In certain operating systems, only the foreground application is visible to the user.

The confusion arises when a user has a number of currently-running applications, but only one of these (or a subset of all running applications) is visible. Therefore, unless a user interface is provided which allows the user to select between currently-running applications it is necessary for the user to remember which applications were previously launched and which ones have not been launched.

In this respect, it is relevant that the processing involved in launching an application is significantly greater than that involved in switching an application between a background mode and a foreground mode. Therefore, in certain situations, a user is presented with two distinct user interfaces; one allowing a user to select an application to be launched and another allowing a user to select an application which has been already launched and which is currently in a background mode which, on selection, is then switched to a foreground mode.

When an application is in the background mode, an event may occur which that application handles, the occurrence of which should be communicated to the user. However, as that application is in the background a user is unaware of the occurrence of the event. Therefore, computing devices utilise notifications to inform a user of the occurrence of an event which they would not otherwise be aware of.

As computing devices increase in complexity, storage capacity and processing power, the number of notifications received also increases. Dealing with too many notifications can make for an unpleasant user experience unless the display of the notifications are managed.

### SUMMARY OF EMBODIMENTS

An embodiment provides an apparatus comprising a user interface manager and a display, said user interface manager being configured to:

i. designate a predetermined display area on said display,

ii. display one or more representations of tasks in said predetermined display area and display one or more indications of events in said predetermined display area.

A further embodiment provides a method comprising:

i. having a user interface manager designate a predetermined display area on a display,

ii. displaying one or more representations of tasks in said predetermined display area, and

iii. displaying one or more indications of events in said predetermined display area.

A further embodiment provides a memory medium storing a computer program executable by a processor of a computing device, said computing device having a notification manager and a display, said computer program performing operations when executed by said processor, said operations comprising:

i. having said user interface manager designate a predetermined display area on a display,

ii. displaying one or more representations of tasks in said predetermined display area, and

iii. displaying one or more indications of events in said predetermined display area.

Embodiments provide a single user interface on which both representations of tasks and indications of events may be displayed. As the events often relate to tasks which are displayed, the notifications corresponding to those events may be associated with the corresponding tasks in a visual manner. This provides a convenient way to associate notifications (or other indications of events) with their corresponding tasks.

### BRIEF DESCRIPTION OF THE DRAWINGS

Embodiments are hereinafter described with reference to the accompanying diagrams where:

FIG. 1 is a schematic representation of a mobile computing device wherein embodiments are implemented;

FIG. 2 is a schematic diagram illustrating the arrangement of hardware components of the computing device of FIG. 1;

FIG. 3 is a schematic diagram illustrating the arrangement of hardware and software components of the computing device of FIG. 1 when arranged according to an embodiment;

FIG. 4 is a further schematic representation of the mobile computing device of FIG. 1;

FIGS. 5 to 9 are user interface manager views according to an embodiment;

FIGS. 10a and 10b provide a flow diagram illustrating the operation of the embodiment of FIGS. 5 to 9.

FIG. 11 is a further user interface manager view according to an embodiment; and

FIG. 12 is a flow diagram illustrating the operation of the embodiment of FIG. 11.

### DESCRIPTION OF EMBODIMENTS

A description of a number of embodiments follows, provided by way of example only.

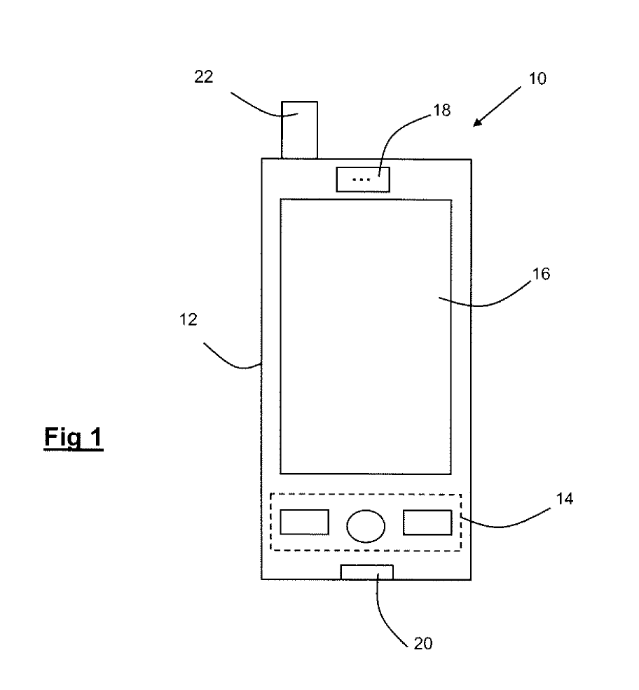

FIG. 1 is a schematic diagram of a computing device 10 having a casing 12. The computing device 10 forms the basis of the embodiments to be described. The casing 12 of the device 10 encapsulates a keypad 14, a touch-screen display 16, a speaker 18 and a microphone 20. The device 10 further includes an antenna 22. The device 10 illustrated in FIG. 1 is a mobile device in that it may be held in a user's hand and used to participate in communication sessions, in particular, telephone calls. During such sessions the device 10 may be utilised so that the speaker 18 is held to a user's ear and the microphone 20 is situated in proximity to a user's mouth.

The device 10 is a computing device which operates as a mobile phone. However, further embodiments relate to other computing devices which do not include telephony as their major function.

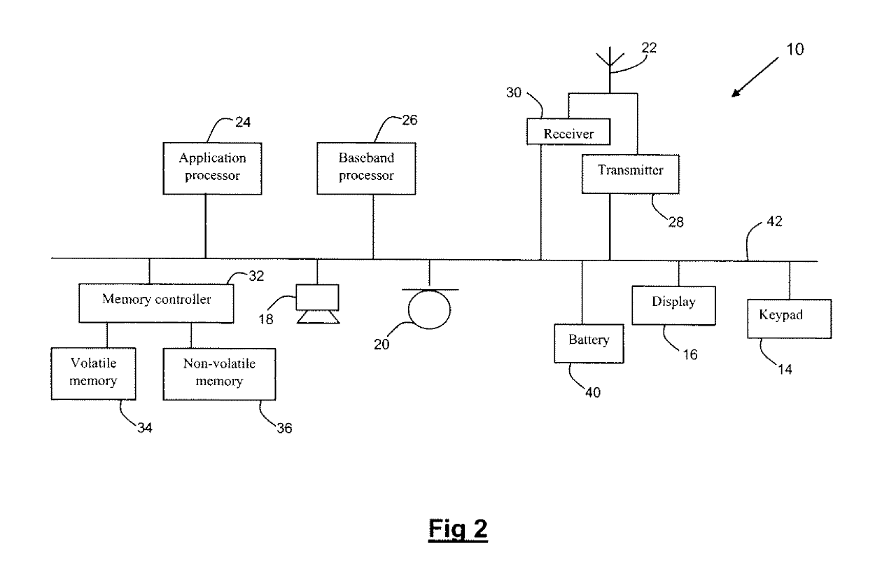

FIG. 2 is a schematic illustration showing the arrangement of the hardware components of the device 10 of FIG. 1. The keypad 14, display 16, speaker 18 and microphone 20 shown in FIG. 1 are connected to a system bus 42. The bus 42 is further connected to an application processor 24, a baseband processor 26, a transmitter 28, a receiver 30 and a battery 40. Transmitter 28 and receiver 30 are connected to the antenna 22. The bus 42 is further connected to a memory controller 32 which is, in turn, connected to volatile memory 34 and non-volatile memory 36. The application processor 24 processes instructions related to various software modules and operating system software which run on the device 10 and which provide various functionality of the device 10. The baseband processor 26 is concerned with the communication functions and to this end controls a telephony stack and communicates with the transmitter 28 and receiver 30 to establish communications by means of the antenna 22. The various processing elements of the device 10 such as the application processor 24 and baseband processor 26 may be provided on a single processor.

Memory controller 32 controls the access to, and interaction with, volatile memory 34 and non-volatile memory 36. In this manner the application processor 24 is able to communicate with the various hardware elements as well as the memory controller 32 and thereby control the operation of the various hardware elements according to software instructions stored on volatile memory 34 or non-volatile memory 36.

Only a single bus, bus 42, is illustrated in FIG. 2. It is to be realised that this bus may be replaced by two or more buses and that the topology of FIG. 2 would vary accordingly. Furthermore, known computing devices include hardware components additional to those illustrated in FIG. 2, but these are well known in the art and are not further described herein.

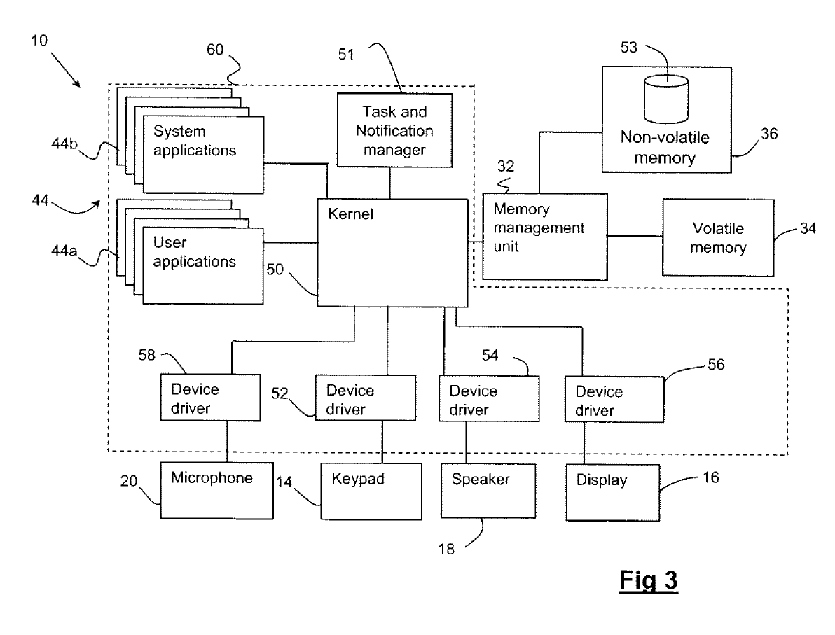

FIG. 3 is a diagram illustrating various hardware and software components of the device 10. The software operating on the device 10 can be categorised in various ways. Certain software operates to manage the resources provided by the various hardware components and to establish an operational environment in which other software executes. This software is known as the operating system of the device and is represented in FIG. 3 by a kernel 50. The kernel 50 interacts with the memory management unit 32 which, as previously described, is connected to volatile memory 34 and non-volatile memory 36. The kernel 50 is further connected to a plurality of applications 44 each of which may access the hardware components in a manner dictated by the kernel 50. The applications 44 include user applications 44a, which may be started and terminated by the user as well as system applications 44b which are operated under the control of the kernel and which the user is not necessarily aware of. The kernel 50 is a multi-tasking operating system capable of running more than one user application simultaneously. When more than a single user application is running, only one of these may be in the foreground and the others are then in the background. The foreground application generally has more processing cycles from application processor 24 assigned to it, accepts input from a user and displays its output on the display 16.

System applications 44b always run in the background in that the user is only aware that these applications are running when they notify the user of the occurrence of an event. Generally, such system applications do not accept input directly from a user. System applications are well known in the art and perform a number of functions such as keep track of hardware states such as the battery charge level, the state of removable memory or networking hardware. System applications are also referred to as ‘daemons’.

Both user and system applications may monitor and react to events occurring which these applications may be aware of. Therefore, an email application, being a user application, may continuously monitor an inbox and register the arrival of a new email as an event. Similarly a chat application may register a new message from one of the participants of the chat as a new event. System applications may also react to events such as the change of state of a hardware resource or the availability of software updates. These events may originate from a change internal to the computing device or from a change outside of the external device.

Both user and system applications may react to the occurrence events by generating a notification. A notification comprises a message to inform the user of the occurrence of the event. Therefore, notifications are generally associated with a particular application. As described below, it is not necessary for applications to react to events by generating notifications; other responses are possible and depend on the application concerned.

The kernel 50 is further connected to a user interface manager 51 for helping a user of the device 10 keep track of running applications 44 and notifications. Notifications are generated by the applications 44, passed to the kernel 50 which then passes them on to the user interface manager 51.

The device 10 further comprises a user interface manager database 53 stored in non-volatile memory 36. The user interface manager 51 interacts with the user interface manager database 53 by means of the kernel 50 and the memory controller 32 in the manner described below.

The kernel 50 is further connected to the keypad 14 by means of device driver 52, to speaker 18 by means of device driver 54 and to the display 16 by means of device driver 56. Only some of the hardware components have been illustrated but, generally, the kernel 50 controls the hardware resources of the device 10 through various device drivers. Furthermore, although the device drivers have been illustrated as separate to the kernel 50, it is possible for them to be incorporated into the kernel 50.

The software components of FIG. 3 are delineated by dashed area 60. However, this distinction between software and hardware is not essential. Components depicted as software in FIG. 3 may be rendered in hardware, and those depicted as hardware may, in certain circumstances, be rendered as software.

During operation of the device, software instructions stored in non-volatile memory 36 establish the kernel 50, the applications 44 and the device drivers 52, 54 and 56. Through the use of the various components illustrated in FIG. 3 a user is able to utilise the device 10 according to the functionality provided by the various applications 44. For example, a user uses the keypad 14 and/or the touch-screen display 16 to communicate with the kernel 50 by means of device drivers 52 and 56 to cause one of the applications 44 to access data stored on non-volatile memory 36 by means of memory management unit 32. The kernel 50 causes the data supplied by memory management unit 32, together with instructions supplied by the application, to be sent to the application processor 24 (FIG. 2). The application processor 24 will return results from the data and instructions, generally utilising volatile memory 34 in the process, and these will be returned to the application by the kernel 50. On further instructions from the application, the kernel 50 will cause the results to be displayed to the user on display 16 by means of device driver 56. It is to be realised that device drivers 52, 54 and 56 are also software components originating from instructions stored on non-volatile memory 36.

The illustration of FIG. 3 is presented merely by way of example; known devices may comprise more components than those shown. Implementations of embodiments are not dependent on the precise arrangement and configuration of components shown in FIGS. 1, 2 and 3. Therefore other components with similar functionality may be substituted and further components added thereto, or illustrated components omitted therefrom, without affecting the operation of embodiments.

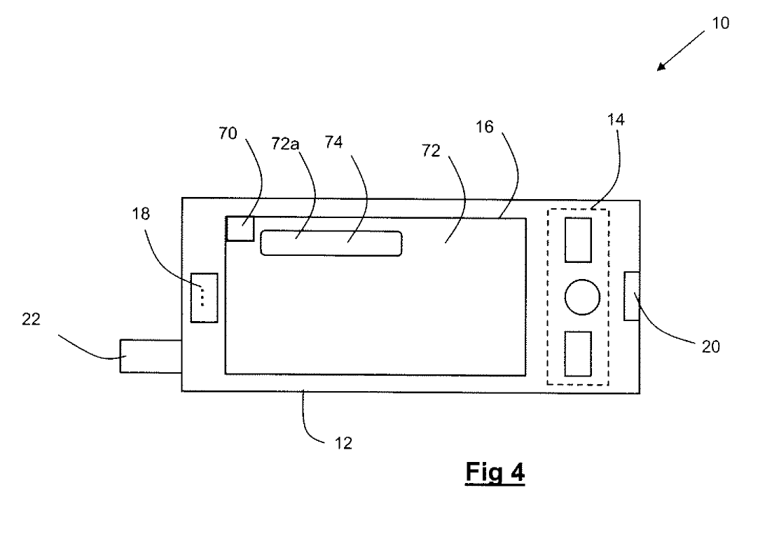

FIG. 4 shows the device 10 of FIG. 1 rotated anti-clockwise through 90 degrees, so that the display 16 is in a landscape orientation. In this orientation, a top-left portion of the display 16 is configured as a button 70. A remaining portion 72 of the display 16 which does not comprise the button 70 provides a conventional display means for the device 10. For example, the remaining portion 72 could display a running user application 44a or a desktop (also known as a ‘home view’).

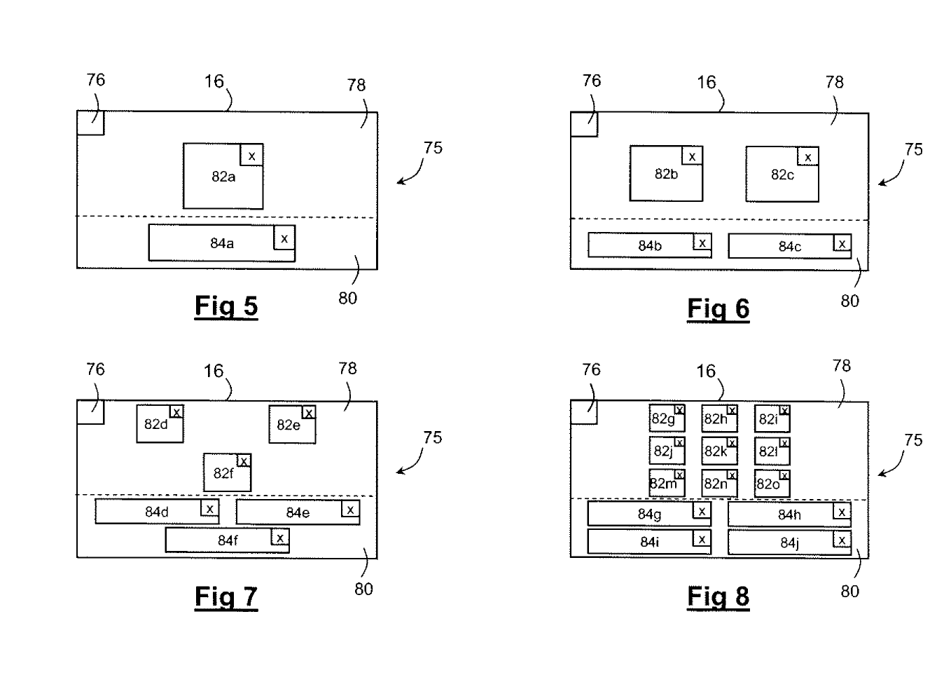

The button 70 is linked with the user interface manager 51 (FIG. 3) and provides a user with a means for activating a user interface comprising a user interface manager view 75 (FIGS. 5 to 8, discussed below). The user interface manager view is a predetermined display area designated by the user interface manager 51, providing a user interface which enables the user to determine which of the user applications 44a are running and which also enables the user to choose one of said running user applications 44a. Furthermore, the user interface manager view comprises a notification display area for simultaneously displaying a plurality of notifications.

As any other user application, the user interface manager 51 may operate in the foreground or in the background. Button 70 is displayed when the user interface manager 51 is in the background and, on user interaction with the button 70, the user interface manager is brought to the foreground. In this respect, the user interface manager 51 differs from other user applications in that it accepts user interaction when a background mode.

FIG. 4 also shows a notification preview 74 on the remaining portion 72 of the display 16 in a top-left region. The notification preview 74 provides a temporary preview of a new notification. More specifically, when a notification is first received or first generated, the user interface manager 51 generates a notification preview 74 on the remaining portion 72 of the display 16. The preview 74 is a temporary message informing the user of the new notification and providing some detail of the notification event. For example, if a new email is received, a notification preview will appear on the display 16 in the position indicated on FIG. 4 and contain the text ‘NEW EMAIL’. The preview 74 will remain on the remaining portion 72 of the display 16 for a short period of time and will remain in front of whatever is currently displayed on the remaining portion 72 of the display 16, such as, for example, the home view or an application view. Therefore, the preview 204 is displayed on a portion of the display 16 which is reserved for the display of notifications, but on a portion which is used for the display of the output of user applications.

In this embodiment, the preview 74 remains for five seconds, after which it fades away. In an alternative embodiment, the preview remains for ten seconds. Importantly, the time period for which the temporary notification preview is visible should be sufficient that the preview is visible to the user, but not so long as to unnecessarily interfere with the user's use of the device 10 (considering that the preview appears in a portion of the display which the user may be using for a particular application).

As illustrated in FIG. 4, the preview 74 is orientated so that it is offset from a periphery of the display 16. Therefore, a part 72a of the remaining portion of the display 72 is visible between the preview 74 and the closest periphery of the display 16. This helps to ensure that the preview is positioned so that it is visible to the user and attracts the user's attention.

FIGS. 5 to 8 provide screen shots of the display 16 of the user interface showing the user interface manager view 75, according to an embodiment. On activation of the button 70 by suitable means, such as, for example, a user's finger or a stylus, the user interface manager view 75 is displayed. Activation of button 76 switches the user interface manager from the background mode, wherein the user interface manager view 75 is not visible on the display 16, to the foreground mode, wherein the user interface manager view 75 is displayed on the display 16.

In the present embodiment, when the user interface manager view is in the foreground mode (as shown in FIGS. 5 to 8) the user interface manager view 75 occupies substantially all of the display 16.

The user interface manager 51 displays notifications in a notification display area 80 of the user interface manager view 75 and representations of tasks in a task display area 78 of the user interface manager view 75.

The task display area 78a may comprise one or a number of active icons 82a to 82o, each one providing a representation of a user application 44a running on the device 10. In the present example, the size of the task view 78a is independent of the number of active icons displayed thereon.

According to the embodiment illustrated in FIGS. 5 to 8, each active icon 82a to 82o is a representation of a display caused by the user application which it relates to. In the embodiment illustrated, the active icons 82a to 82o are reduced size representations of the entire display which would be visible were the corresponding user application currently running in the foreground. In this respect, the icons are active in that their representations of the output of the corresponding user application is being continually updated when they are displayed in the user interface manager view 75.

In an alternative embodiment, the representation may be a zoomed-in and centred representation of the display which would be visible if the corresponding user application were running in the foreground. The representation enables a user of the device 10 to instantly identify a running user application by looking at its corresponding representation.

Each of the active icons 82a to 82o contains a top-right portion marked with the symbol ‘x’. The portion of each active icon marked ‘x’ provides a button which the user may use to terminate the user application corresponding to the active icon. Furthermore, the user interface manager view 75 of FIGS. 5 to 8 contains a button or icon positioned in a top left portion and marked with a reference sign 76. The button 76 takes the place of the button 70 when the user interface manager 51 is in the foreground mode. Also, the button 76 enables the user to move the user interface manager 51 from the foreground mode back to the background mode, wherein the button 70 again takes the place of the button 76.

The active icons 82a to 82o are laid out in accordance with layout rules. The layout rules are stored and implemented by the user interface manager 51. Firstly, the layout rules ensure that all active icons are positioned clearly on the task view 78a. Secondly, the layout rules ensure that each active icon is sized to maximise the space available on the task view 78a, and thereby make it as easy as possible for the user to identify which running user application is being represented by each active icon.

In the present embodiment, the layout rules are such that the position and size of each active icon is dependent on the number of active icons displayed. The following explains the implementation of the layout rules to generate FIGS. 5 to 8.

FIG. 5 represents a case where there is only one running user application, where active icon 82a represents the running user application. Active icon 82a is sized larger than the active icons of FIGS. 6 to 8, and is positioned in the centre of the task view 78a.

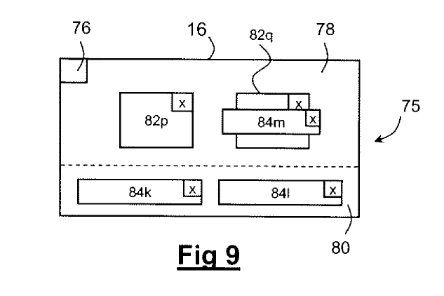

FIG. 6 represents a case where there are two running user applications (a second user application has been launched), wherein active icons 82b and 82c represent the two running user applications. In this case, it is to be realised that active icon 82b represents the same user application as active icon 82a. Active icons 82b and 82c are sized smaller than the active icon in FIG. 5 but larger than those in FIGS. 7 and 8. Also, the active icons are horizontally centred on the task view 78a.

FIG. 7 represents a case where there are three running user applications, wherein active icons 82d to 82f represent the three running user applications (where active icon 82d represents the same user application as active icons 82a and 82b of FIGS. 5 and 6, respectively). Active icons 82d to 82f are sized smaller than the active icons in FIGS. 5 and 6 but larger than those in FIG. 8. Also, each row of active icons is vertically centred in the task view 78a, although the top row contains two active icons 84d and 84, whereas the lower row contains only a single active icon 84f.

Finally, FIG. 8 represents a case where there are nine running user applications, where active icons 82g to 82o represent the nine running user applications (the same user applications being represented here as illustrated in FIGS. 5, 6 and 7, as well as additional user applications). Active icons 82g to 82o are sized smaller than the active icons in FIGS. 5, 6 and 7 to allow all active icons to be represented on the task view 78a. Also, each row of active icons is centred in the task view 78a. In the present example, there is a predetermined maximum number of active icons which can be displayed on the task view 78a. In the present example, the maximum number is nine, as illustrated in FIG. 8.

It is also important to note that that the active icons displayed on the task view 78a are ordered in a corresponding sequence to the order in which the applications to which the active icons related were launched. For example, consider the situation in which the user of the device 10 first turns the device 10 on, and then activates the following user applications in the following order, a photograph gallery, a calendar and a camera. If the user then activated the button 70 from the camera application view, the layout of the user applications would correspond to FIG. 7, wherein three active icons are shown. Moreover, the order of the active icons corresponds to the order in which the three user applications were launched. Therefore, the active icon 82d would represent the photograph gallery, the active icon 82e would represent the calendar and the active icon 82f would represent the camera. Similarly, FIG. 5 illustrates the situation where a single user application is running and FIG. 6 the situation where two user applications are running. Therefore active icons 82a and 82b would represent the photograph gallery application and active icon 82c the calendar application.

In the embodiment illustrated, the icons are placed on the task display area 78 in the order the corresponding user applications are launched. Specifically, the icons are first placed left to right and then top to bottom. Therefore, in FIG. 8, the order in which the active icons are placed (and therefore the order in which the corresponding user applications were launched) would be: 82g, 82h, 82i, 82j, 82k, 82l, 82m, 82n and 82o.

An advantage of operating in this way is that the active icons maintain the same relative order to one another. This makes it easier for the user to locate a running user application using its active icon. If an active icon's location could change, the user would have to identify the location of each active icon each time the user interface manager view 75 was brought to the foreground, which may be rendered more difficult by the fact that the appearance of the active icon changes together with the output of the program concerned, therefore making identification more difficult. Keeping the order of the active icons constant improves the user experience by assisting in the identification of the active icons.

The only exception to this ordering is when an active icon is removed when the corresponding user application is terminated. In this case, the positions of other active icons which are present are adjusted in accordance with the above-mentioned layout rules. However, it is to realised, that the order of the remaining active icons will be retained and that this will be representative of the order in which the corresponding user applications were launched.

When the user actives the button 70 to move the user interface manager 51 from the background mode to the foreground mode, one or a number of active icons are displayed in dependence on which user applications 44a are running at that time. If during the course of subsequently operating the device 10 the user terminates one or more of those running user applications, the next time that the user actives the button 70 (either from an application view or the home view) the active icons corresponding to those terminated applications will not be displayed on the user interface manager view. In order to enable this functionality the user interface manager 51 maintains the database 53 with entries for user applications 44a which are currently running on the device 10 stored on non-volatile memory 36. More specifically, each time a user application is launched, the kernel 50 instructs the user interface manager 51 to add a corresponding entry to the database 53. Further, each time a user application is terminated, the kernel 50 instructs the user interface manager 51 to remove a corresponding entry from the database 53. Then, when the user selects button 70 to bring the user interface manager 51 to the foreground, the user interface manager 51 inspects the database 53 to identify which of the user applications 44a are currently running. Then, the user interface manager 51 loads an active icon only for those user applications which have an entry in the database 53. According to this operation, the user interface manager 51 is capable of accurately keeping track of the currently running user applications.

In addition to the user interface manager view 75 providing a way in which the user may identify, at any chosen time, which user applications are currently running, the user interface manager view also allows the user to switch running user applications. In other words, the user interface manager view allows the user to switch a running application from a background mode into the foreground mode. More specifically, in FIGS. 5 to 8, each of the active icons 82a to 82o may be selected by suitable means, such as, for example, a user's finger or a stylus tapping on the active icon, to switch the application to the foreground so that the user can continue operating it. For example, a user may start a word processing application and start writing a new document but realise that they require information from the internet in order to finish the document. In this situation, the user may launch an internet browser and begin browsing the internet while the word processing document is still running in the background. While using the browser, the user can select button 70 (from the browser's application view) to bring the user interface manager 51 into foreground mode. Assuming the user does select button 70, one of the active icons displayed on the user interface manager 51 will correspond with the running word processing application. According to this example, the user can select the corresponding active icon to switch the word processing application to foreground mode and cause this application to be displayed on the display 16 and allow the user to continue writing the document.

The user interface manager view 75 also provides a means to interact with running applications in addition to closing and returning them to the foreground. In particular, if two or more active icons are displayed on the user interface manager view, the active icons may interact with each other by having the user interface manager 51 instruct the corresponding applications perform certain operations. For example, assume that four active icons are present, the first active icon representing a browser application, the second active icon representing an address book application, the third active icon representing an instant messenger application, and the fourth active icon representing a photography gallery application. Dragging the browser's active icon onto the instant messaging application's active icon causes a hyperlink to the currently viewed internet page to appear on the current messaging conversation. Additionally, dragging the address book's active icon onto the messaging application's active icon causes an invitation to the current messaging conversation to be sent to the person whose address details are currently displayed by the address book. Additionally, the direction of the dragging operation can determine the operation performed by the user interface manager 51. For example, dragging the photograph gallery application's active icon onto the browser's active icon causes the current image from the photograph gallery to be opened by the browser. Alternatively, dragging the browser's active icon onto the photograph gallery application's active icon causes the current image from the browser to be stored in the photograph gallery.

As mentioned above, the user interface manager view comprises the notification display area 80 in addition to the task display area 78. The notification display area 80 can comprise one or a number of icons, each one relating to at least one notification received or generated by the device 10. In the present example, the size of the notification display area 80 is independent of the number of icons displayed thereon. The icons are illustrated on FIGS. 5 to 8 by the reference signs 84a to 84j. According to this embodiment, each icon provides information regarding the notification which it relates to. For example, an icon for a notification relating to a new email event may include the text ‘NEW EMAIL’ and additionally may include the email subject and sender. Moreover, in the present embodiment, the icon may relate to more than one event. Under the aforementioned example if two email messages were received, instead of displaying the ‘NEW EMAIL’ message twice, a single icon with the message ‘2 NEW EMAILS’ is displayed. In any case, the principle of the icon is to enable a user of the device 10 to instantly identify the event which it related to and to relay the information of the notification(s) to the user.

In the present embodiment, the size of the notification display area 80 is independent of the number of icons displayed thereon. Furthermore, the size of the notification display area does not change. Advantageously, this renders the layout of notifications in the area delimited by the area 80 relatively straightforward as changes in the size of the area need not be taken account of.

Further, each of the icons 84a to 84j contains a top-right portion marked with the symbol ‘x’. The portion of each icon marked ‘x’ provides a button which the user may use to remove the notification from the notification view 78b.

The icons 84a to 84j are laid out in accordance with the same layout rules discussed above with reference to the task view 78. In the illustrated embodiment, there is a predetermined maximum number of icons which can be displayed in the notification display area 80. In the present example, the maximum number is four, as illustrated in FIG. 8.

It is also important to note that that the icons displayed on the notification display area 80 are ordered in a sequence corresponding to the order in which the notifications are received by the user interface manager 51. For example, consider the situation in which the following notifications are received in the following order: a new email message, a new SMS message and a low battery notification. If the user then activated the button 70 from the home view or an application view, the layout of the notification icons would correspond with FIG. 7, wherein three icons are shown. Moreover, the order of the icons would correspond to the order in which the three notifications were received or generated. Therefore, the icon 84d would here represent the new email, the icon 84e would represent the new SMS message and the icon 84f would represent the low battery notification. An advantage of operating in this way is that it makes it easier for the user to identify notifications using its icon. If an icon's location could change, the user would have to identify the location of each icon each time the notification manager view was brought to the foreground. This would waste the user's time and lead to a worse user experience. The only exception to this operation is when an icon is closed. In this case, the positions of the remaining icons are adjusted in line with the above-mentioned layout rules, but their relative positions remain the same (i.e. the positions of the remaining icons is dependent on the order in which the corresponding notifications are received).

When the user actives the button 70 to move the user interface manager 51 from the background mode to the foreground mode, one or a number of icons are displayed in dependence on which notifications have been received or generated before that time.

Furthermore, notifications may be cleared. This generally occurs if, during the course of subsequently operating the device 10, the user views the events relating to those notifications (by, for example, viewing the application to which the notification relates). The manner in which a notification may be cleared will depend on the notification concerned. Some notifications will clear automatically after a predetermined time whereas others require user interaction. In any event, when the user actives the button 70 (either from an application view or the home view) the icons which have been cleared will not be displayed on the notification manager view. In a further embodiment, any notifications which have not been cleared by a user after a predetermined time are automatically cleared.

In order to enable this functionality the user interface manager 51 maintains the database 53 with entries for notifications which are running on the device 10. More specifically, each time a notification is received or generated, the user interface manager 51 adds a corresponding entry to the database 53. Further, each time a notification is cleared by the user, the user interface manager 51 removes the corresponding entry from the database 53. Then, when the user selects button 70 to bring the user interface manager 51 to the foreground, the user interface manager 51 loads an icon only for those applications which have a corresponding entry in the database 53. According to this operation, the user interface manager 51 is capable of accurately keeping up to date with which notifications are still relevant to the user.

In addition to the notification display area 80 providing means for the user to identify, at any chosen time, which new events have occurred, the notification view 78b also allows the user to handle those events. More specifically, on FIGS. 5 to 8, each of the icons 84a to 84j may be selected by suitable means, such as, for example, a user's finger or a stylus, to launch the application corresponding to that notification (i.e. to start running the application) or to bring that application to the foreground.

For example, while using the device 10 to browse the internet the device 10 may receive a new email. According to the above described operation, a preview of the notification will first be temporarily displayed on the browser applications view (as described above with reference to FIG. 4). At some later time the user may select button 70 (e.g. from the browser's view or the home view by tapping on the icon) to bring the user interface manager 51 into foreground mode. An icon displayed on the notification view 78b will correspond to the new email event. According to this embodiment, the user may select the corresponding icon to launch the email application on the display 16 and view the new email.

As illustrated in FIG. 9, the user interface manager 51 is further capable of determining whether or not a user application corresponding to a notification is running on the device 10. In this case, the icon relating to the notification icon is displayed on top of the active icon relating to the corresponding running user application in the task display area 78, rather than in the notification display area 80. In this instance, the size and shape of the icon of the notification is adjusted so that it is better aligned with the active icon over which it is superimposed. The notification icon is made smaller and thinner than those icons positioned in the notification display area 80.

In FIG. 9, the task display area 78 contains two active icons 82p and 82q, and the notification view 78b contains two icons 84k and 84l. Additionally however, the task display area contains a notification icon 84m positioned on top of active icon 82q so that it is superimposed thereon. The notification icon 84m corresponds to the user application represented by active icon 82q.

An advantage of operating in this way is that it frees up an amount of available room in the notification display area 80 and therefore permits more notifications to be displayed simultaneously. Further, this operation does not negatively affect the task display area 78 as it is clear to the user that the user application represented by the active icon 82q is the same as the application to which the notification of icon 84m relates. If the user selects either the visible part of the active icon 82q or the icon 84m the user interface manager 51 will launch the corresponding application or cause that application to be brought to the foreground.

In order to increase the display area of the notification display area 80, the user interface manager 51 can group together notifications relating to similar events. For example, two new emails are received by the device 10 while the user is using the device 10 to browse the internet. Each time a new email is received a preview 74 relating to that email will be temporarily displayed on the browser's application view. If the user activates the button 70 from the browser's view to launch the user interface manager view 75, only a single icon represents both new emails on the notification view 78b. However, the text of the icon indicates that the icon relates to two notifications which have been grouped together. For example, the text reads ‘2 NEW EMAILS’ rather than ‘NEW EMAIL’. According to this operation, the user interface manager 51 is able to preserve the space available on the display area of the notification display area 80 and thereby notify the user of more events.

According to the present embodiment, when the user interface manager view 75 is visible, i.e. the user interface manager 51 is in the foreground mode, notification previews 74 are not displayed. Instead, a new notification icon is displayed on the notification display area 80 as soon as the new notification is received or generated. However, in a further embodiment, the user interface view 75 is not divided up into a task display area and a notification display area. Instead, both active icons and notification icons are displayed in the user interface manager view in the order in which they occur.

Referring back to FIG. 4, according to the present embodiment, when a notification preview 74 fades away, the button 70 changes to indicate to the user that a new notification has been received or generated and can be viewed in the notification display area 80. By operating in this way the button 70 acts as a prompt to make it known to the user that a new notification can be viewed on the notification display area 80. The button 70 may prompt the user by flashing or by changing colour. As the button 70 only appears when the user interface manager 51 is in the background mode, the prompt associated with the button 70 occurs when the user interface manager view 75 is not visible on the display 16.

According to the present embodiment, if the user selects a notification preview 74 when it is displayed on the home view or an application view, the user interface manager 51 instructs the kernel 50 to launch the application which handles or is associated with the event which the notification preview relates to, or bring that application to the foreground. For example, if the notification preview relates to a new email message, then if the user selects the preview, via suitable selecting means, such as a finger or a stylus, the email application is launched or brought to the foreground. In this case, as the notification will have been seen by the user before the user interface manager 51 has an opportunity to display an icon relating to the notification on the notification display area 80, no such icon will appear the next time the user views the user interface manager view 75.

According to the present embodiment, the first time that the user views a notification via the notification view 78b, that notification is highlighted to indicate to the user that they have not seen the notification in the user interface manager view 75 before (the user may, or may not, have seen the corresponding, temporary notification preview). For example, the icon relating to an unseen notification may flash or change colour. If the user chooses to ignore the notification and activate button 76 to move the user interface manager 51 to the background mode, the next time the user activates the button 70 to move the user interface manager 51 to the foreground view the notification will no longer be highlighted. For example, the icon will no longer flash or the colour will revert back. The advantage of operating in this way is that the user can instantly see when entering the user interface manager view 75 which events have not been seen before in this view. Accordingly, the user does not waste time looking at old notifications.

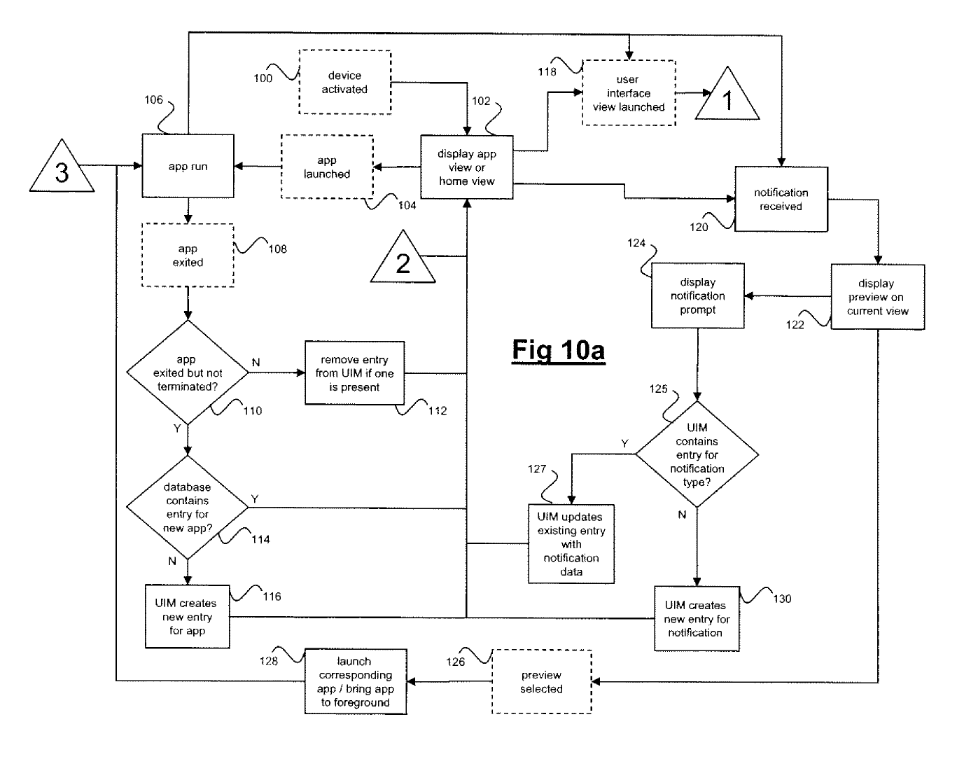

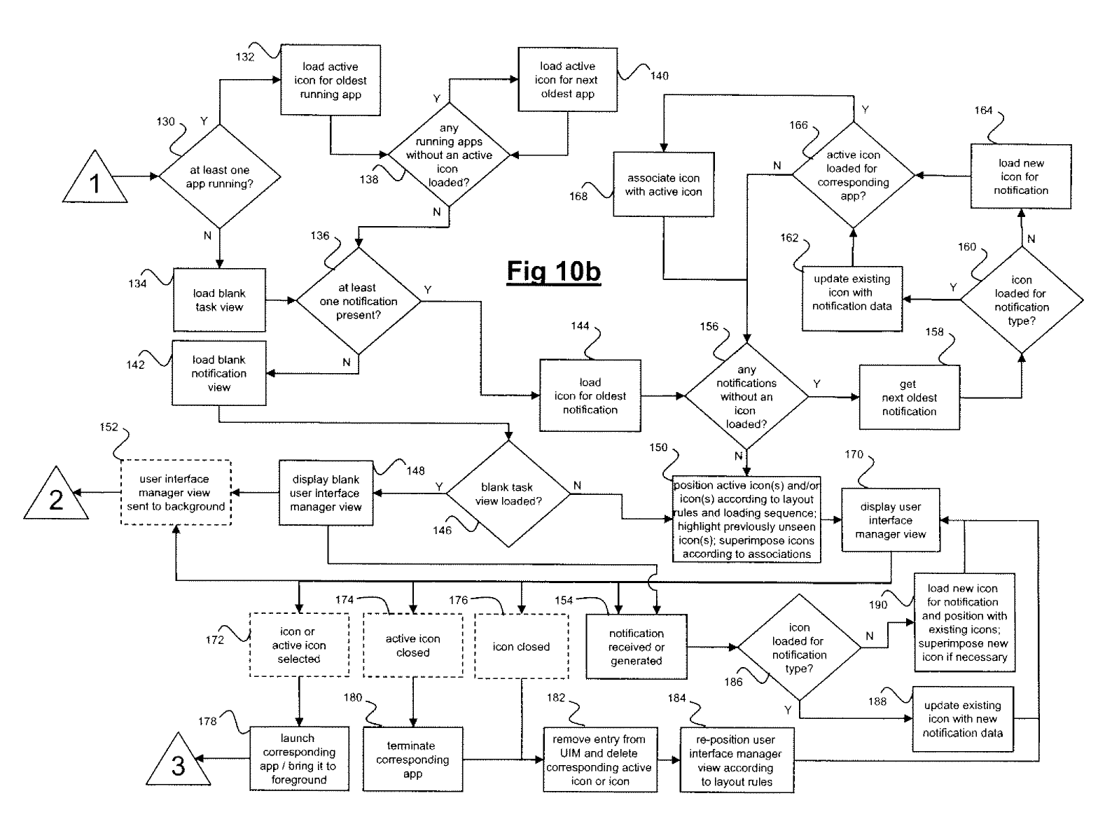

FIGS. 10a and 10b provide a flow diagram of the operation of an embodiment. It is noted that within FIGS. 10a and 10b, there are four different styles of step. Rectangular-shaped steps with a continuous boarder indicate processing steps performed by the device 10. Rectangular-shaped steps with a dashed boarder indicate processing performed as a result of an input received from a user, such as, for example, an interaction between a stylus and the touch screen display 16. Diamond-shaped steps indicate a binary question, wherein the alternative answers to the question are indicated by the letters ‘Y’ and ‘N’ on flow paths leaving the step. Triangular-shaped steps indicate transitions between FIGS. 10a and 10b.

Operation according to FIGS. 10a and 10b begins at step 100. At step 100, a user of the device 10 turns it on and the device boots up. Once the device is ready for operation processing flows to step 102. At step 102, the device waits in a home view (also know as a desktop view) until the user issues another instruction. If the user launches one of the user applications 44a, such as a word processing application, processing flows to step 104. Once the word processing application (or other user application) has been launched at step 104, processing flows to step 106. At step 106, the application is run by the application processor 24. For example, the user begins writing a new document. While the application is running, the user interface manager view 75 may be launched in a manner described below. If this is done, the process will proceed from step 106 to step 118. Furthermore, while the application is running, the device 10 may receive or generate a notification in a manner described below. If this occurs, the process will proceed from step 106 to step 120.

Once the user has finished writing (in the aforementioned example) or would prefer to start another application, processing flows from step 106 to step 108. At step 108, the word processing application is exited and processing flows to step 110. Two principle ways in which the user may exit an application are: firstly, the user may terminate the application, i.e. close it down, and secondly, the user may start another user application, i.e. move the first application to the background so that it is no longer displayed on the display 16.

At step 110, the device 10 determines whether or not the user application has been exited but not terminated. If the word processing application has been terminated then processing flows to step 112. At step 112 the kernel 50 requests that the user interface manager 51 identifies if an entry in database 53 for the user application exists, and if it does, the kernel 50 requests that the user interface manager 51 removes the entry. Processing then flows back to step 102, wherein the device 10 displays the home view or a different application view (depending on a number of factors such as whether other applications are running and the order in which any other applications were previously accessed). In the present case, the device 10 will display the home view as no other applications are running.

Alternatively, if at step 110 the user application has been moved to the background but not terminated, processing flows to step 114. At step 114, the kernel 50 requests that the user interface manager 51 identify whether an entry exists in database 53 for the user application. If the database 53 does contain an entry, processing flows to step 102, where the device 10 displays either the home view or a different application view. For example, if a new application, such as an internet browser, has been launched directly from the first application (e.g. via a hyperlink in a document), at step 102, the device 10 will display the new application's view (i.e. display the browser). Alternatively, if the user exited the first application to start another application from the home view, at step 102, the device 10 will display the home view.

If, at step 114, the user interface manager 51 does not contain an entry in its database 53 for the exited user application, a new entry is created at step 116. A new entry is created in this instance as the user application is being exited but not terminated and therefore, although the user is no longer using the user application, it is still running in the background. Processing then flows from step 116 back to step 102, wherein the home view or another application view is displayed, as discussed above.

According to the above operation, the user interface manager 51 is capable of monitoring the user applications which are running on the device 10. In particular, all of those user applications running in the background will have a corresponding entry in the user interface manager's database 53.

At step 102, while in either the home view or an application view, if a notification is generated, processing flows from step 102 to step 120. Also, as mentioned above, processing may also flow to step 120 from step 106. At step 120, the notification is received by the user interface manager 51, following which processing flows to step 122. At step 122, a notification preview 74 is displayed on the current view (as described above with reference to FIG. 4), where the current view comprises either the home view (i.e. if processing flows from step 102) or an application view (i.e. if processing flows from step 102 or 106).

The notification preview 74 remains on the display 16 for a temporary period (five seconds in the current embodiment) and then fades away. Once the notification preview 74 has been displayed at step 122, processing flows to step 124 (discussed below), unless the user selects the preview 74, in which case processing flows to step 126.

From step 126 processing flows to step 128, wherein the user interface manager 51 instructs the kernel 50 to launch the application to which the notification preview 74 relates. For example, if the notification preview 74 relates to a new email message which has been received, if the user selects the preview 74, using suitable selection means, such as a finger or a stylus, the corresponding email application is launched. However, if the email program is already running in the background then the device brings the application to a foreground mode instead of launching it. Once the application corresponding to the notification has been started, processing flows to step 106, which was discussed above.

As mentioned briefly above, if at step 122 the user does not select the preview 74, processing flows to step 124. At step 124, the user interface manager 51 displays a prompt to the user on the current view to indicate to the user that there are new notifications on the user interface manager view 75. As mentioned above, a suitable prompt may be the button 70 flashing or changing colour. In the current embodiment, the prompt is only displayed for the first notification received while the notification manager 200 is in a background mode. Therefore, at step 308, the notification manager will determine if the prompt is already displayed and whether the notification manager 200 is in a background mode. If either of these apply, the prompt will not be displayed at step 308.

Once the prompt has been activated, if appropriate, processing flows to step 125. At step 125, the user interface manager 51 identifies if an entry exists in database 53 for the type of notification received at step 120. For example, if the notification relates to a new email message, at step 125, the user interface manager 51 identifies an entry in database 53 relating to a new email already exists. If the user interface manager 51 does contain an entry for the type of notification received or generated at step 120, processing flows from step 125 to step 127, otherwise processing flows from step 125 to step 130. At step 127, the user interface manager 51 updates the existing entry in database 53 with the new notification data. At step 130, the user interface manager 51 creates a new entry in database 53 for the new notification. In either case, processing flows back to step 102, which is discussed above.

According to the above operation, the user interface manager 51 is capable of keeping up to date with notifications as they are received by the user interface manager 51. In particular, all new notifications will have a corresponding entry in the user interface manager's database 53 until the icon corresponding to the notification has been seen by the user.

From step 102, the user may decide to bring the user interface manager 51 into the foreground to make the task and notification view 75 visible on the display 16. As mentioned above, the button 70 appears in the top left corner of the home view and each application view and the user may launch the user interface manager view 75 by activating the button 70. Once the user activates the button 70 processing flows from either step 102 or step 106 to step 118, wherein the user interface manager 51 is brought to the foreground and the user interface manager view 75 is launched. Processing then flows to step 131 (FIG. 10b), wherein the user interface manager 51 identifies if at least one user application 44 is running in the background. The present embodiment performs this operation by identifying if there are any entries in the task manager database 53 relating to running user applications 44. If there are such entries then at least one user application is running and processing flows to step 132, which is discussed later. Alternatively, if there are no such entries in the database 53 then it is determined that no user applications are running and processing flows to step 134.

At step 134, the user interface manager 51 loads a blank task display area 78. More specifically, the user interface loaded comprises a button 76 (FIGS. 5 to 8) but no active icons. Processing then flows from step 134 to step 136, discussed below.

Alternatively, if at step 131 it is determined that there is at least one user application running then, as mentioned previously, processing flows to step 132. At step 132, the user interface manager 51 loads an active icon for the oldest running user application. Each time the user interface manager 51 adds an entry to database 53 the new entry is added to the end of the current list. Therefore, the user interface manager 51 is able to identify the order in which the applications are started by inspecting the order of entries in the database 53. At step 132, the user interface manager 51 loads an active icon for the first entry in the database 53 (i.e. the oldest running user application). The process of loading an active icon involves rendering the active icon with an up-to-date representation of the display caused by the corresponding application. For example, the user interface manager 51 will load an up-to-date screenshot via the kernel 50 and render the active icon with the image.

Once the active icon has been loaded at step 132, processing flows to step 138. At step 138, the user interface manager 51 identifies if there are any other running user applications. More specifically, the user interface manager 51 identifies if there are any other entries corresponding to running user applications in database 53. If there is at least one such entry, processing flows from step 138 to step 140. At step 140, the user interface manager 51 loads an active icon for the next oldest application. The process then returns to step 138. Importantly, the order in which active icons are loaded for running user applications corresponds with the order in which the applications themselves were loaded. Processing flows in a loop between steps 138 and 140 as long as there are running applications for which an active icon has not been loaded.

Once an active icon has been loaded for each running user application, processing flows from step 138 to step 136. Alternatively, if only one user application is running, processing flows directly from step 138 to step 136, i.e. the flow bypasses step 140.

As mentioned previously, processing flows to step 136 once either a blank task display area 78 is loaded or an active icon for each running application 44 is loaded. At step 136, the user interface manager 51 identifies if at least one notification is present. The user interface manager 51 does so by inspecting database 53 to identify whether any entries relating to notifications are present. If no such entries are present in the database 53, processing flows to step 142, otherwise processing flows to step 144, which will be discussed later. At step 142, the user interface manager 51 loads a blank notification display area 80 without displaying notification icons. Processing then flows from step 142 to step 146, wherein the user interface manager 51 identifies if a blank task display area 78 has been loaded (i.e. did processing flow through step 134?). If a blank task display area 78 has been loaded, processing flows to step 148, otherwise processing flows to step 150, discussed below.

At step 148, the user interface manager 51 displays a blank user interface manager view 75. Stated differently, the display 16 comprises a button 76 (FIGS. 5 to 9) but no active icons or notification icons. From step 148, the user can select the button 76 to move the user interface manager 51 to the background to hide the blank task and notification view 75. In this case processing flows to step 152 and then on to step 102 (FIG. 10a, which is discussed above. Alternatively, if while the blank task and notification view 75 is being displayed the device receives or generates a new notification, processing flows to step 154, which will be discussed later.

As mentioned briefly above, if at step 136 the user interface manager 51 identifies that at least one notification entry exists in database 53, processing flows to step 144. At step 144, the user interface manager 51 loads an icon for the oldest notification entry. The oldest notification entry corresponds to the oldest notification icon not seen by the user. The process of loading the icons may involve retrieving relevant information relating to the notification. For example, if the notification relates to a new email message, retrieved data may comprise the email subject and/or the email sender. Once the icon and any relevant data has been loaded, processing flows from step 144 to step 156.

In one example, system related notifications will only be displayed if they meet specified criteria. In this example, the system notifications are designated as either urgent or non-urgent and only the urgent notifications are displayed. In yet a further example, the user is able to specify which notifications are to be displayed. This may occur, for example, by allowing the user to specify which notifications are considered to be urgent, or allowing the user to specify applications, the notifications corresponding to which are always displayed or always hidden.

At step 156, the user interface manager 51 identifies if there are any remaining notification entries in its database 53. Stated differently, the user interface manager 51 identifies if there are any other notifications for which an icon has yet to be loaded. If there are further notifications then processing flows to step 158, otherwise processing flows to step 150, discussed below.

At step 158, the user interface manager 51 obtains the next oldest entry from the database 53, following which processing flows to step 160. At step 160, the user interface manager 51 identifies whether an icon has already been loaded for the type of notification relating to the currently-processed notification. If such an icon has already been loaded for this type of notification, then processing flows to step 162, otherwise processing flows to step 164.

At step 162, the pre-existing notification of the same type is updated to contain information relating to the currently-processed notification. At step 164, a new notification is created for the new notification. For example, if the oldest and next oldest entry relate both relate to new email messages, an email notification will be loaded at step 144 and this notification will be updated at step 162 to relate to a second email. Alternatively, if the next oldest entry relates to a new SMS message, an email notification will be loaded at step 144 and an SMS notification will be loaded at step 164. In either case, processing from both steps 162 and 164 flows to step 166.

At step 166, the user interface manager 51 identifies if an active icon has been loaded for a user application corresponding to the notification updated or created in step 162 or step 164, respectively. If no active icon has been loaded for a corresponding user application then processing flows from step 166 back to step 156. If an active icon has been loaded for a corresponding user application then processing flows from step 166 to step 168. At step 168, the user interface manager 51 associates the notification icon with the active icon relating to the corresponding application.

In the embodiment illustrated, the notification icon is associated with the active icon for the corresponding user application by superimposing the icon for that notification over the active icon for that user application in the manner described above with reference to FIG. 9.

From step 168 processing then flows back to step 156. Processing will continue to flow in the above-described loop between steps 156; 158; 160; 162 or 164; and, 166 and 168, or 166, so long as there are notifications for which icons have not been loaded. Once an icon has been loaded for all notifications processing flows from step 156 to 150.

As mentioned briefly above, processing flows to step 150 from either step 146 or step 156. At step 150, the user interface manager 51 positions each loaded active icon on the task display area 78 and each loaded icon on the notification display area 80 or task display area (if a corresponding icon exists there). More specifically, positioning is performed according to the layout rules mentioned above and the user interface manager 51 ensures that the order of the active icons and notification icons matches the order in which they were loaded (as previously mentioned). This order also matches the order in which either the corresponding applications were first launched, or the corresponding notifications were first generated. Additionally, the user interface manager 51 superimposes icons over active icons according to any associations created during processing at step 168. Once the active icons and icons have been positioned in step 150, processing flows to step 170. At step 170, the user interface manager 51 displays the user interface manager view 75, as illustrated by FIGS. 5 to 9.

According to the above operation the user can select the button 70 from the home view or an application view to launch a user interface manager view comprising an active icon for each application running on the device 10 and an icon for each notification generated.

From step 170, processing may take five different possible paths, via steps 152, 172, 174, 176 and 154. The following explains each path in turn.

Firstly, the user may, from step 170, exit the user interface manager view by selecting the button 76 which switches the user interface manager 51 to the background mode. In this case processing flows from step 170 to step 152, discussed above.

Secondly, at step 170, the user may select any part of an active icon or icon (excluding the top-right portion) to bring the corresponding user application to the foreground (or launch it) and enable the user to continue operating the user application or view the notification event. In this case processing flows from step 170 to steps 172 where the user selects the icon and then to 178 where the application is launched. From step 178, the process proceeds to step back to step 106 (FIG. 10a). Processing from step 106 is discussed above.

Thirdly, from step 170, the user can select the top-right portion of an active icon to terminate the corresponding user application without bringing it back to the foreground. In this case, processing flows from step 170 to steps 174 where the active icon is closed by the user and 180 where the corresponding user application is terminated. Once the corresponding user application has been terminated at step 180, processing flows to step 182, wherein the corresponding entry in database 53 is removed. This action confirms that the application will not be considered a running user application (until it is launched again). The corresponding active icon is also removed from the task display area 78. Processing then flows to step 184 wherein the remaining active icons on the task view 78a are re-positioned in accordance with the layout rules mentioned above, in order to take advantage of the additional space freed up by the removal of one active icon. Processing then flows back to step 170.

Fourthly, from step 170, processing may flow to step 176 if the user selects the top-right portion of a notification icon displayed in the notification display area 80, or in the task display area 78 if the icon is superimposed on an active icon. Once the user has selected the top-right portion of an icon, processing flows to step 182, discussed above. A user may opt for this operation if, for example, the user interface manager 51 has provided an icon relating to a unwanted or spam email.

Fifthly, from step 170, processing may flow to step 154 if a new notification is generated. As mentioned above, processing can also flow to step 154 from step 148, discussed above. Processing from step 154 is performed as follows. As the user interface manager view is currently visible (i.e. the user interface manager 51 is in the foreground mode) notification previews are not displayed. Therefore, once a new notification is generated, processing flows to step 186. At step 186, the user interface manager 51 identifies whether an icon has already been loaded for the same type of notification as the new notification. If an icon of this type has already been loaded, processing flows to step 188, otherwise processing flows to step 190. At step 188, the pre-existing notification of that type is updated to contain information relating to the new notification. At step 190, a new icon is loaded for the new notification and positioned according to the aforementioned layout rules. Also, the new notification is highlighted to indicate that the user has not seen it before. Additionally, the new notification is superimposed on an active icon if one is loaded for a corresponding application. Processing from both steps 188 and 190 then flows back to step 170, discussed above.

According to this operation, the user is able to use the user interface manager view to identify which user applications are running at any given time, bring any one of the running user applications to the foreground, and close any one of the running applications without having to bring that user application to the foreground. It is an advantage of this embodiment that the user can quickly and effectively manage all running user applications from one predetermined display area. Additionally, it is an advantage that because the order of the active icons does not change the user can quickly identify the active icon for a particular user application by remembering its relative location. Additionally, it is an advantage that the user can quickly identify which active icon relates to which running user application because the active icon comprises a representation of the display caused by the corresponding user application.

Further according to the above-described operation, the user is able to use the user interface manager to view and manager new and unseen notifications at any chosen time. Additionally, the user interface manager provides a means for the user to quickly access the user application relating to a new or unseen event, if applicable. Additionally, the user interface manager provides a means for the user to ignore particular events without launching the corresponding user application. Additionally, the user interface manager shows a preview of a new notification and a prompt indicating to the user that new notifications are present. It is an advantage of this embodiment that the user can quickly and effectively manage notifications from one predetermined display area. Additionally, it is an advantage that because the order of the icons does not change the user can quickly identify the location of the corresponding icon for a particular notification. Additionally, it is an advantage that the user can quickly identify which notification icons have not been seen before, as they are highlighted. Further, it is an advantage that a user can identify which new events relate to applications which are running on the device 10.

The present embodiment is also capable of allowing a user to cause two or more active icons to interact with one another. For example one active icon may be dragged onto another active icon to cause the user interface manager 51 to perform certain operations, as discussed above.

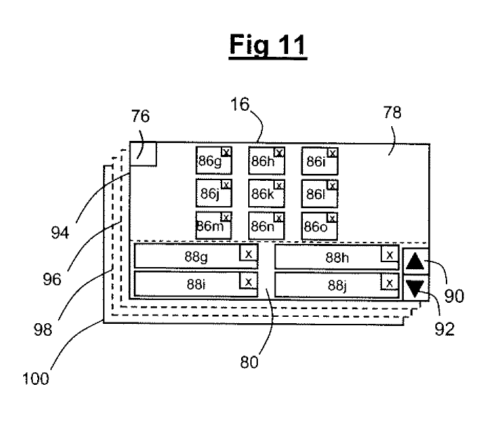

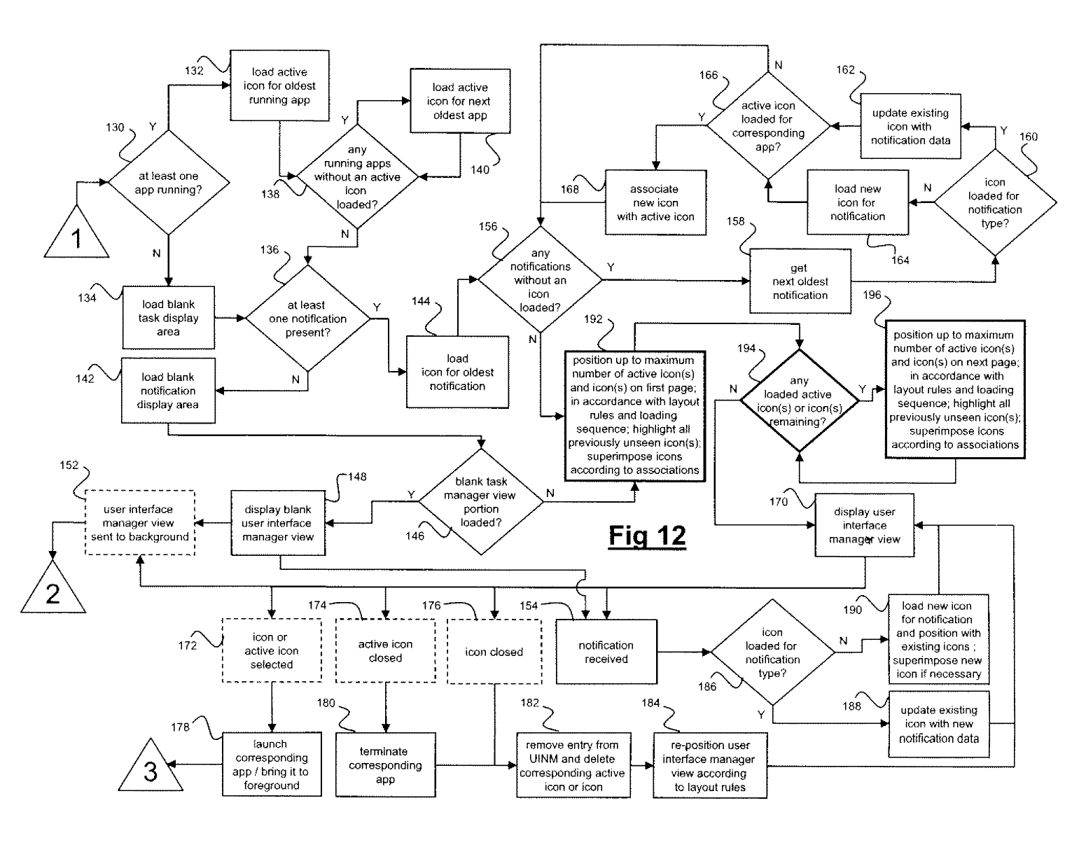

FIGS. 11 and 12 provide a screen shot and flow diagram according to another embodiment. FIG. 10 illustrates a user interface manager view 77 in multi-page format. In particular, when more than nine applications are running, or more than four notifications have been received or generated, the user interface manager view may span across a number of different pages, wherein each page may comprise a maximum number of active icons and icons. In the present example the maximum number of active icons (in the task view 78a) is nine and the maximum number of icons (in the notification view 78b) is four. This is illustrated on FIG. 10, wherein a user interface manager view is shown in multi-page format. In particular, nine active icons are displayed 86g to 86o, and four icons are displayed 88g to 88j. Additionally, new buttons 90 and 92 are displayed in the bottom-right corner of the notification view 78b portion of the user interface manager view. The button 90 enables the user to cycle through the different user interface manager view pages. In FIG. 10, four user interface manager view pages are shown, 94, 96, 98 and 100. Additionally, the button 92 enables the user to cycle through the different user interface manager view pages (94, 96, 98 and 100) in the opposite direction to button 90. The number of user interface manager view pages is dependent on the number of running applications, and the number of notifications generated.

In this embodiment a predetermined display area has been divided into pages 94, 96, 98 and 100 in each of which no more than a maximum number of active icons and icons may be displayed.

FIG. 12 provides a flow diagram illustrating how the multi-page format user interface manager view is generated by the present embodiment. The following describes the aspects of FIG. 12 which are different from FIG. 10b. In particular, in FIG. 12, step 150 of FIG. 10b has been replaced by new steps 192, 194 and 196. At step 150, the user interface manager 51 positions the first nine loaded active icons on the task display area 78 and the first four icons on the notification display area 80 according to the procedure mentioned above. This operation ensures that the first page contains the active icons for the first nine running applications to be launched, and the first four notifications generated. Additionally, notifications icons relating to user applications for which active icons on the page exist are superimposed on the active icon, as mentioned previously. Processing then flows from step 192 to step 194. At step 194 the user interface manager 51 establishes if there are any more loaded active icons or loaded notification icons to be positioned. In this embodiment this will only be the case if there are more than nine running applications, or more than four notification icons. If there are more loaded active icons or notification icons, processing flows from step 194 to step 196, alternatively processing flows from step 194 to step 170, which is discussed above with reference to FIG. 10b.

If processing flows to step 196, the user interface manager 51 positions up to the nine loaded active icons, and up to four loaded icons on the next user interface manager view page, according to the procedure mentioned above. This operation ensures that the second page contains the active icons for the tenth to eighteenth running applications launched, and the fifth to eighth notifications received or generated. Processing then flows from step 196 back to step 194 and will continue to flow in a loop around these two steps so long as there are loaded active icons and/or notification icons which have not been positioned on a user interface manager view page. Once all loaded active icons and/or notification icons have been positioned on a page, processing flows from step 194 to step 170, which is discussed above with reference to FIG. 10b.

It is an advantage of this embodiment that any number of active icons and notification icons may be displayed on the user interface manager view. Although FIG. 11 illustrates four pages, the number of pages will be determined by the number of active icons and icons to be displayed, and pages are created at step 196 as desired.

As before, the order of the icons and active icons on a page does not change thereby enabling the user to quickly identify an active icon or notification icon. The only exception to this rule occurs when active icons or notification icons are terminated. In this case, remaining active icons or notification icons are moved to fill in the empty space, but their relative positions remain the same.

According to the present example, when the button 70 is activated by the user, the user interface manager view page which was last viewed by the user is the one to be displayed on the display 16. To do so, the user interface manager 51 keeps a record of the page last viewed by the user. If the user has not viewed any page previously, the first page is loaded. An advantage of this operation is that the user is able to locate the active icon or icon relating to a particular task or event more quickly and this leads to an improved user experience.

In the embodiments discussed above, the task switcher button 70 comprises a software button positioned in a top-left portion of the display 16 in a landscape orientation. In alternative embodiments the button 70 is positioned elsewhere on the display 16, such as, in a bottom-right portion. Furthermore, in further embodiments the button 70 is a hardware button, positioned within the keypad 14 or positioned elsewhere on the device 10. Further still, such a hardware button could be provided by a pre-existing button or by a newly designated button.

In an alternative embodiment, instead of loading notification icons as described in FIGS. 10a and 10b, the user interface manager, when processing an event which would otherwise result in a notification being displayed superimposed on an active icon, causes that active icon to blink. In yet further embodiments, the active icon is caused to pulsate or to be highlighted.

In an alternative embodiment, the user interface manager 51 provides a user interface in which a user may customise the manner in which the user interface manager 51 operates. For example, the user may specify the maximum number of icons permitted in a notification manager view or page. Alternatively, the user may specify the minimum and/or maximum sizes for an icon.

The aforementioned embodiments have been described with reference to certain arrangements of hardware and software. The invention is not however limited in this respect and it is known to provide certain components described above as hardware components instead as software components in alternate embodiments. Similarly, components described above as software may instead be provided as hardware such as, for example, application specific integrated chips.

What is claimed is:

1. Apparatus comprising a user interface manager and a display, said user interface manager being configured to:
designate a predetermined display area on said display,
display one or more representations of tasks in said predetermined display area and display one or more indications of events in said predetermined display area.

2. The apparatus according to claim 1 wherein at least one of said events relates to a task, said task having a corresponding representation displayed in said predetermined display area, said user interface manager being configured to change said representation corresponding to said task as said indication of said event.

3. The apparatus according to claim 1 wherein said user interface manager is configured to alternatively or additionally display a notification as said indication of said event.

4. The apparatus according to claim 3, wherein at least one of said notifications corresponds to a task for which a representation is displayed and wherein said user interface manager is configured to superimpose said at least one notification on said representation of said corresponding task.

5. The apparatus according to claim 1 wherein said user interface manager is configured to be switched between a background mode in which said predetermined area is not visible and a foreground mode wherein said predetermined display area is visible and to display a prompt when a notification occurs when said user interface manager is in said background mode.

6. The apparatus according to claim 5 wherein said prompt is an icon.

7. The apparatus according to claim 1 wherein said user interface manager is configured to additionally display said notification displayed temporarily, in said predetermined display area.

8. The apparatus according to claim 1 wherein said user interface manager is configured to distinguish between notifications previously displayed and new notifications.

9. The apparatus according to claim 8 wherein notifications previously displayed comprise notifications previously displayed in said predetermined display area when said user interface manager is in a foreground mode and said new notifications comprise notifications displayed temporarily when said user interface manager is in said background mode.

10. The apparatus according to claim 1 wherein said user interface manager is configured to suppress display of one or more selected notifications.

11. The apparatus according to claim 10 wherein said user interface manager is configured to select said one or more selected notifications according to one or more user specified criteria or according to one or more system criteria.

12. The apparatus according to claim 1 wherein said user interface manager is configured to divide said predetermined area into a task display area and a notification display area, display said representations of tasks in said task display area, and display one or more notifications in said notification display area.

13. The apparatus according to claim 12 wherein said user interface manager is configured to arrange notifications in said notification display area in an order in which said notifications are generated.

14. The apparatus according to claim 12 wherein said user interface manager is configured to arrange representations in said task display area in an order in which said corresponding tasks are launched.

15. The apparatus according to claim 12, wherein said user interface manager is configured to be switched between a background mode in which said predetermined area is not visible and a foreground mode wherein said predetermined display area is visible, said predetermined area comprising one or more pages, and wherein said user interface manager is configured to:
when returning to said foreground mode, display a selected page where said selected page is a page last displayed when previously in said foreground mode.

16. A method comprising:
having a user interface manager designate a predetermined display area on a display;
displaying one or more representations of tasks in said predetermined display area; and
displaying one or more indications of events in said predetermined display area.

17. The method according to claim 16 wherein at least one of said events relates to a task, said task having a corresponding representation displayed in said predetermined display area, said method comprising changing said representation corresponding to said task as said indication of said event.

18. The method according to claim 16 comprising alternatively or additionally displaying a notification as said indication of said event.

19. The method according to claim 18, wherein at least one of said notifications corresponds to a task for which a representation is displayed, said method comprising superimposing said at least one notification on said representation of said corresponding task.

20. The method according to claim 16 wherein said user interface manager is configured to be switched between a background mode in which said predetermined area is not visible and a foreground mode wherein said predetermined display area is visible, said method comprising displaying a prompt when a notification occurs when said user interface manager is in said background mode.

21. The method according to claim 20 wherein said prompt is an icon.

22. The method according to claim 16 comprising additionally displaying said notification displayed temporarily, in said predetermined display area.

23. The method according to claim 16 comprising distinguishing between notifications previously displayed and new notifications.

24. The method according to claim 23 wherein notifications previously displayed comprise notifications previously displayed in said predetermined display area when said user interface manager is in a foreground mode and said new notifications comprise notifications displayed temporarily when said user interface manager is in said background mode.

25. The method according to claim 16 further comprising suppressing display of one or more selected notifications.

26. The method according to claim 25 further comprising selecting said one or more selected notifications according to one or more user specified criteria or according to one or more system criteria.

27. The method according to claim 16 further comprising dividing said predetermined area into a task display area and a notification display area, displaying said representations of tasks in said task display area, and displaying one or more notifications in said notification display area.

28. The method according to claim 27 further comprising arranging notifications in said notification display area in an order in which said notifications are generated.

29. The method according to claim 27 further comprising arranging representations in said task display area in an order in which said corresponding tasks are launched.

30. The method according to claim 27, wherein said user interface manager is configured to be switched between a background mode in which said predetermined area is not visible and a foreground mode wherein said predetermined display area is visible, said predetermined area comprising one or more pages, said method further comprising displaying a selected page when said user interface manager returns to said foreground mode, said selected page being a page last displayed when previously in said foreground mode.

31. A memory medium storing a computer program executable by a processor of a computing device, said computing device having a notification manager and a display, said computer program performing operations when executed by said processor, said operations comprising:
having said user interface manager designate a predetermined display area on a display;
displaying one or more representations of tasks in said predetermined display area; and
displaying one or more indications of events in said predetermined display area.
